(19) United States
(12) Patent Application Publication
(10) Pub. No.: US 2013/0097740 A1
(43) Pub. Date: Apr. 18, 2013

(54) Scanning probe microscopy-based metrology tool with a vacuum partition

(71) Applicant: The Board of Trustees of the Leland Stanford Junio, Palo Alto, CA (US)

(72) Inventors: James F. Mack, Portola Valley, CA (US); Philip B. Van Stockum, Redwood City, CA (US); Yonas T. Yemane, Mountain View, CA (US); Friedrich B. Prinz, Woodside, CA (US)

(21) Appl. No.: 13/705,701

(22) Filed: Dec. 5, 2012

Related U.S. Application Data
(63) Continuation-in-part of application No. 13/548,845, filed on Jul. 13, 2012.
Application No. 13/548,845 is a continuation of application No. 12/383,467, filed on Mar. 23, 2009, now Pat. No. 8,296,859.
(60) Provisional application No. 61/070,636, filed on Mar. 24, 2008.

(51) Int. Cl. G01Q 60/10

(52) U.S. Cl. CPC G01Q 60/10
USPC 850/26

(57) ABSTRACT

A method of monitoring of semiconductor processes is provided that includes monitoring the processes using a scanning probe microscope (SPM), where a first partition is located below a second partition, where the second partition is hermetically isolated from the first partition, where a SPM probe tip of the SPM is disposed in the first partition, where a remaining portion of the SPM is disposed in the second partition that is hermetically isolated from the first partition, and where the semiconductor processes may occur in either the first partition or a third partition.

### CROSS-REFERENCE TO RELATED APPLICATIONS

This application is a continuation-in-part of U.S. patent application Ser. No. 13/548,845 filed Jul. 13, 2012, which is incorporated herein by reference. U.S. patent application Ser. No. 13/548,845 is a continuation of U.S. patent application Ser. No. 12/383,467 filed Mar. 23, 2009, which is incorporated herein by reference. U.S. patent application Ser. No. 12/38346 claims the benefit from U.S. Provisional Application 61/070,636 filed Mar. 24, 2008, and which is hereby incorporated by reference.

### FIELD OF THE INVENTION

The invention relates to relates to a device to inspect features on a sample during semiconductor manufacturing. More particularly the invention relates to a scanning probe microscope with a sample chamber that is separated from the microscope components by a partition.

### BACKGROUND OF THE INVENTION

Many semiconductor processing techniques are designed to control materials at the nanoscale. Success of the process depends on nanoscale features such as step height, grain size, film roughness, and material composition. In a manufacturing environment, these nanoscale features must be produced with high repeatability. Measuring these features is necessary to determine yield and to diagnose and correct process problems. Scanning probe microscopy (SPM) provides a method for performing such nanoscale measurements.

Typical scanning probe microsope-based metrology tools require the sample to be transferred from the manufacturing environment, through the ambient atmosphere, before insertion into the metrology tool. Even the existing metrology tools that incorporate a vacuum environment do not separate the sample from the microscope components. Thus, the sample is exposed to contamination from the microscope components. This prevents mid-process characterization.

What is needed is device that is capable of in situ topographical measurements of early stage ALD growth at working conditions of rough vacuum and elevated temperature, where the sample can be analyzed in a clean environment and be inspected in situ at times when analysis by ex situ methods would cause contamination of the sample.

### SUMMARY OF THE INVENTION

To address the needs in the art, a method of in situ monitoring of semiconductor processes is provided that includes monitoring the semiconductor processes in situ using a scanning probe microscope (SPM), where a second partition is located above the first partition, where the second partition is hermetically isolated from the first partition, where a SPM probe tip of the SPM is disposed in the first partition, where a remaining portion of the SPM is disposed in the second partition that is hermetically isolated from the first partition.

According to one aspect of the invention, the semiconductor process includes an atomic layer deposition (ALD) process in the first partition, where the ALD process includes a viscous-flow process utilizing sequential flow and purging of precursor and oxidant species to deposit a thin film.

According to another aspect of the invention, the semiconductor process can include deposition, etching, polishing, thermal, annealing, cleaning, liftoff, lithography, or implantation. In one aspect, the materials used in the semiconductor process can include semiconductors, metals, or insulators.

In a further aspect of the invention, the in situ monitoring includes mid-process characterization of the thin film, where the mid-process characterization enables early detection of errors in processing, where defective wafers are recycled or reprocessed.

According to another aspect of the invention the in situ monitoring includes mid-process characterization of the thin film, where the mid-process characterization includes determination of features in the thin film, where the features can include trench depth, material composition, feature height, feature spacing or size uniformity.

In yet another aspect of the invention, in situ monitoring includes mid-process characterization of the thin film, where the mid-process characterization can include characterization of micro-electromechanical systems (MEMS) to determine dimensions.

According to another aspect of the invention, the in situ monitoring comprises cycle-by-cycle in situ imaging.

In a further aspect of the invention, a pressure differential between the first partition and the second partition is up to 10 torr.

In another aspect of the invention, a pressure ratio exists between the first partition and the second partition, where the pressure ratio includes a pressure less than 10⁻⁶ Torr in the first partition and a pressure in the second partition that is less than 10 Torr.

According to a further aspect of the invention, in situ monitoring includes measuring a local density-of-states (LDOS) of features on a sample.

In another aspect of the invention, the semiconductor processes occurs in the first partition.

In yet another aspect of the invention, the semiconductor process occurs in a third partition, where the third partition is mechanically connected to the first partition and the second partition. In one aspect, the first partition and the third partition includes a cluster tool, where substrates are passed between the cluster tool by robotic transfer arms while remaining isolated from an ambient environment, where the substrate remains in a vacuum environment during the processing.

### BRIEF DESCRIPTION OF THE DRAWINGS

FIGS. 1(a)-1(c) show 1(a) External view of the STM-ALD instrument, 1(b) upper chamber (outer diameter 30.5 cm), including the upper portion of the scanner and the coarse approach motors, and 1(c) lower chamber, including the tip and tip holder protruding through the partition, and the plungers which support the sample stage, according to one embodiment of the invention.

FIG. 2 shows a cross sectional schematic of the vacuum chamber, where the Y piezo is omitted for clarity), according to one embodiment of the invention.

FIGS. 3(a)-3(d) show vibration and tunneling current noise spectra for low 3(a) and high 3(b) frequency ranges, 3(c)-3(d) stationary STM current noise measured at room temperature using a tunneling current of 1 nA and bias of 0.3 V, with PI gains turned down to 1% to remove effects of the control loop, according to one embodiment of the invention.

FIG. 4 shows XPS depth profile of a ZnS film grown in the STMALD tool, where one hundred cycles of ALD using diethylzinc and hydrogen sulfide were performed to grow this film. The estimated sputter etching rate was ˜5 nm/min, according to one embodiment of the invention.

FIG. 5 shows constant current topograph on highly oriented pyrolytic graphite (HOPG) demonstrating atomic resolution. Image acquired at room temperature with a sample bias of 0.1 V and a current set point of 1 nA, according to one embodiment of the invention.

FIGS. 6(a)-6(b) show 6(a) constant current topograph on gold(111) after hydrogen flame annealing, where image acquired at room temperature with a sample bias of 1 V and a current set point of 0.2 nA, 6(b) profile of the dotted line shown in 6(a), arrows indicate examples of single atomic step edges, measuring the known height for gold(111) of 0.23 nm, according to one embodiment of the invention.

FIG. 7 shows a differential conductivity spectrum of a 30 nm thick PbS film grown by 500 cycles of ALD, according to one embodiment of the invention.

FIGS. 8(a)-8(f) show in situ STM topographs of ALD precursors on the Au(111) substrate at room temperature 8(a) before deposition, 8(b) after 1 cycle, 8(c) after 2 cycles, 8(d) after 3 cycles, 8(e) after 4 cycles, and 8(f) after 5 cycles of diethylzinc and hydrogen sulfide. Images are constant-current topographs taken at a sample bias of 0.3 V and a current set point of 0.03 nA, according to one embodiment of the invention.

FIGS. 9(a)-9(l) show a series of STM topographs on the same site showing progression of the nucleation and growth of ZnS during the first 25 cycles of ALD. Inset numbers refer to the number of H₂S/DEZ cycles completed before acquiring the image. Before any exposure to precursors, sharp atomic steps are visible on the clean Au(111) surface. After 3 pulses of H₂S to prepare the surface for deposition, etching of the Au surface is observed on this and most samples. After the first cycle, nucleation of individual islands is visible. By the third cycle, the film is continuous. Deposition and imaging occurred at a sample temperature of 160° C. and a chamber temperature of 60° C. All topographs acquired in constant current mode at 300 mV sample bias, 30 pA current setpoint, and scan speed of 4 lines/sec. Total elapsed time was 3 hr. All images share the same lateral and vertical scale.

FIGS. 10(a)-10(f) show STM topographs showing the effects of various environmental conditions on the first cycles of ZnS ALD. Inset numbers refer to the number of H2S/DEZ cycles completed before acquiring the image. 10(a) Physisorption with sample and chamber at room temperature. 10(b)-10(e) ALD growth at 60° C., 100° C., 130° C., and 160° C., respectively. Diagonal lines in 10(e) are due to ambient noise. 10(f) Runaway growth of ZnO, with chamber at 25° C. and sample at 160° C. All topographs acquired in constant current mode. Topographs in (e) acquired at 100 pA, 300 mV, and 4.8 lines/sec. All others acquired at 30 pA, 300 mV, and 4 lines/sec.

FIGS. 11(a)-11(c) show 11(a) Constant current STM cross-section profiles, spatially registered over 25 cycles of ZnS ALD. The vertical spacing between profiles is arbitrary, and the vertical scale is highly exaggerated. Each profile is the average of seven adjacent scan lines, with a resolution of 2.56 lines per nanometer. 11(b) Constant current STM topograph of the 25th cycle, with box showing the region of interest. 11(c) Constant current STM topographs of the region of interest during 25 cycles of ALD. The central transparent lines indicate the data displayed in 11(a). Inset numerals denote the number of cycles completed prior to acquisition of each image. All topographs in 11(c) have the same lateral and vertical scale. Deposition and imaging occurred at a sample temperature of 160° C. All topographs acquired in constant current mode at 300 mV sample bias, 30 pA current set point, and scan speed of 4 lines/sec. Total elapsed time was 3 hr.

FIGS. 12(a)-12(b) show statistical grain measurements. 12(a) Statistical representation of grain profiles as a function of cycle number and temperature. Thick lines represent the median grain height at each lateral position; thin lines represent the 25^{th} and 75^{th} percentiles of grain height. The vertical scale is highly exaggerated. 12(b) Variation in the mean grain height, diameter and aspect ratio as a function of cycle number and temperature. Error bars represent one standard deviation from the mean. Data in (a) and (b) reflect measurements on 40 grains (2 samples) at 100° C., 40 grains (2 samples) at 130° C., and 60 grains (3 samples) at 160° C.

FIGS. 13(a)-13(b) show changes in surface morphology in the initial cycles of ALD for films deposited at 160° C. (top) and 100° C. (bottom). All images in each temperature group have the same lateral and vertical scale and were acquired at the same location on the surface. Numbers above each image refer to the number of H₂S/DEZ cycles completed prior to image acquisition. Merging of two pairs of grains (red arrows) and rearrangement before formation of a prominent grain (green arrows) are visible at 160° C., while no such mobility is visible at 100° C. As an example, the blue arrows point to a grain, which did not change morphology between cycles 1 and 7.

FIG. 14 shows variation in grain diameter within a single sample. Film deposited at 160° C. 100 grains measured at each cycle. Central lines represent medians, box edges represent 25^{th} and 75^{th} percentiles, and whiskers represent extrema.

FIGS. 15(a)-(k) show H₂S etching and then ZnS deposition on Au(111) at 160° C.

FIGS. 16(a)-16(b) show TEM data showing a ZnS film grown by 50 cycles of ALD at 160° C. 16(a) is a cross-sectional micrograph that shows the film to be crystalline and 4.2 nm in thickness. Some regions do not appear to show crystallinity in this image due to narrow depth of focus. 16(b) is a selected-area diffraction pattern that shows film crystallinity. Both wurtzite (lower, broad rings) and zincblende, or sphalerite, (lower narrow rings) phases are present. Some zincblende rings are omitted from the simulation results in the lower-left due to overlap with wurtzite rings.

FIG. 17 shows XPS depth profile of a representative ZnS film grown with 50 cycles of ALD at 160° C. Estimated sputter rate is 2 nm/min.

FIG. 18 shows saturation of ZnS growth rate with pulse time. Each data point represents a depth profile from a different sample. All samples deposited with 50 cycles of ALD at 160° C. Measurement resolution is 0.2 Å/cycle.

FIGS. 19(a)-19(c) show grain size data, averaged by sample. Lines represent mean data and error bars represent standard deviation. Data are from samples with deposition temperature of 160° C. (solid lines), 130° C. (dashed lines), and 100° C. (dotted lines). Twenty grains were measured on each sample, and the same grains were tracked and measured from cycle to cycle.

FIG. 20 shows a schematic diagram of the partitioned in situ monitoring tool integrated with a semiconductor processing cluster, where the substrate is moved by a mechanical transfer arm from the monitoring tool to other cluster chambers.

### DETAILED DESCRIPTION

This invention is a metrology tool for semiconductor manufacturing. The tool incorporates a scanning probe microscope. The tool is partitioned so that the sample is not exposed to the microscope components, wherein the invention is used for metrology during semiconductor manufacturing. This partitioned configuration allows the tool to be mounted on a cluster tool for mid-process characterization. Mid-process characterization enables early detection of errors in processing, allowing defective wafers to be recycled or reprocessed. According to one embodiment, the mid-process characterization of wafers during semiconductor manufacturing enables determination of trench depth, material composition, feature height, feature spacing, size uniformity, capacitance, elastic modulus, and any other measurement that can be performed with a scanning probe microscope. Further, the invention enables mid-process characterization of micro-electromechanical systems (MEMS) and related devices to determine dimensions. The invention is not limited to the transistor and memory industry. For example, MEMS devices can also be measured mid-process.

The partitioned configuration in the present invention allows the sample to be imaged in a clean and controlled environment. This environment can be a high vacuum, which allows the tool to be mounted on a cluster tool used for semiconductor manufacturing, and allows mid-process inspection to be performed.

A combined scanning tunneling microscope-atomic layer deposition (STM-ALD) tool is described that performs in situ imaging of deposition. While the type of SPM used in the following embodiment is a scanning tunneling microscope (STM), any type of SPM can be used with similar results. In this embodiment, the system operates from room temperature up to 200° C., and at pressures from 1×10⁻⁶ Torr to 1×10⁻² Torr. The STM-ALD system has a complete passive vibration isolation system that counteracts both seismic and acoustic excitations. The instrument can be used as an observation tool to monitor the initial growth phases of ALD in situ, as well as a nanofabrication tool by applying an electric field with the tip to laterally pattern deposition. The design of one embodiment of the tool is described to demonstrate its capability for atomic resolution STM imaging, atomic layer deposition, and the combination of the two techniques for in situ characterization of deposition.

Scanning probe techniques such as STM offer the capability to perform high resolution imaging of atomic-scale structures. STM is a flexible technique, with the capability to operate over wide ranges of temperature and pressure. This enables its use in making high-resolution, in situ observations of processes such as ALD. In addition to observing deposition, the ability of STM to manipulate matter at the molecular scale presents an opportunity to go beyond the spatial limits of electron-beam lithography to ultimately achieve atomic resolution in nanostructure fabrication.

A combined tool is provided that performs in situ characterization of ALD with a STM. The instrument is capable of performing cycle-by-cycle in situ imaging of ALD, providing time-resolved imaging of a single site, spatially registered to the nanometer scale. The tool can also be used to perform nanolithography by activation of ALD or decomposition of ALD or CVD precursors. In addition to STM mode, the instrument can be run in AFM mode, particularly for samples, which are not electrically conductive.

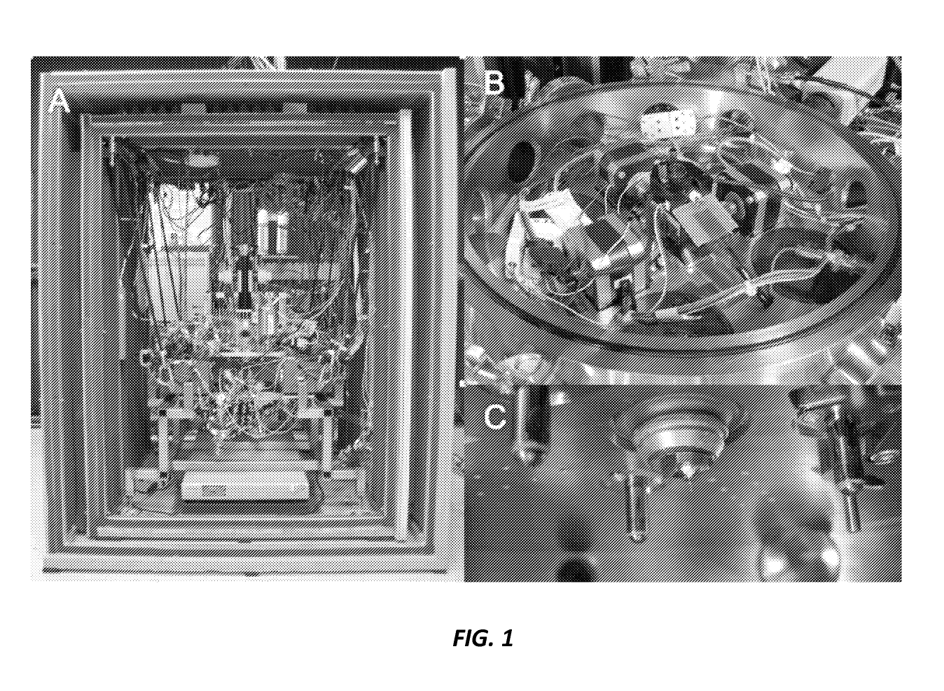

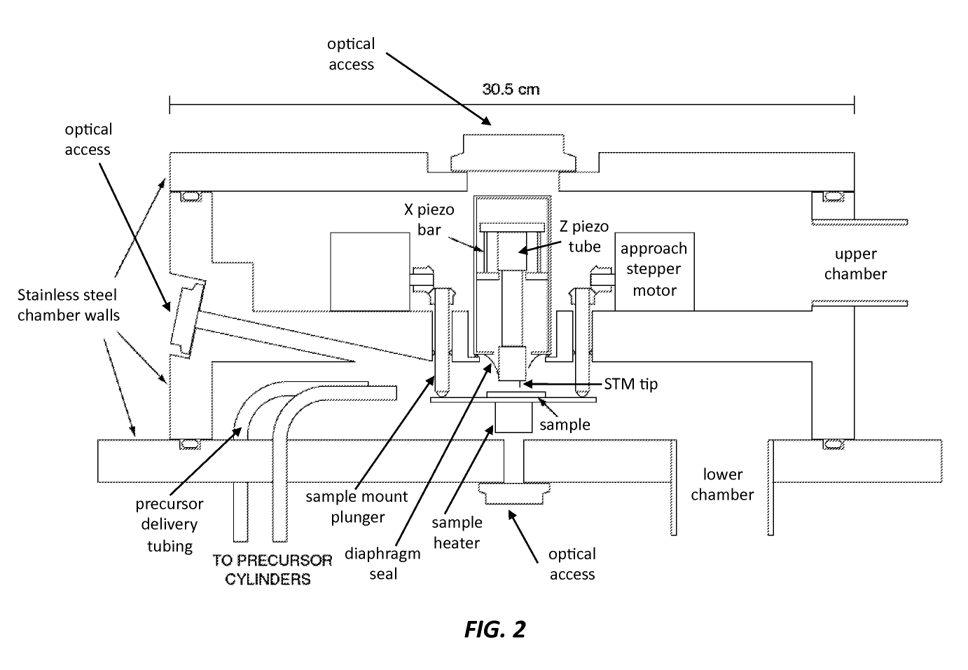

Performing in situ STM observations of an isotropic deposition process such as ALD presents significant practical challenges, the most fundamental of which is that the two techniques must operate independently of each other. The deposition cannot degrade the imaging performance, and the imaging components cannot contaminate the deposition. This decoupling is provided by the STM-ALD tool according to the current invention, where by partitioning the vacuum system into two halves, an upper section and a lower section (FIGS. 1a-1c and FIG. 2). In this example of one embodiment, the lower section contains the sample, tip, and deposition process. The upper section contains the microscope components, including the piezoelectrics used in scanning, the stepper motors used for approach, and optics which enable the microscope to be used as an AFM in addition to STM.

Although the components in the upper chamber do not require vacuum, the practical geometry requirements of the system necessitate the chamber's evacuation. Since the tip holder penetrates the partition and is sealed by an elastomer diaphragm, any pressure on the diaphragm is opposed by axial forces in the scanning piezo elements. Thus, large pressure differentials between the two sections can result in stresses in the piezos, which are significant enough to cause fracture. To prevent this, the two chambers are always kept within 10 Torr of each other, which requires pumping down from and venting back to atmospheric pressure through a set of needle valves. The upper chamber is kept at rough vacuum (1×10⁻³ Torr). The lower chamber may be pumped to high vacuum (1×10⁻⁶ Torr) without causing critical forces, as although the pressure ratio may be high, the pressure differential and thus the force is not.

The diaphragm, which seals the tip holder, allows the tip to be placed proximal to the sample while isolating the microscope from the deposition process. This isolation is critical, as deposition from just a few hundred ALD cycles can result in mechanical fouling of moving parts, electrical shorting, and coating of optical components, resulting in disabling of the microscope. Outgassing from the microscope components can contaminate the deposition environment, negatively affecting the purity of the sample under study. Furthermore, sequential purging of the precursor vapors is a critical step in ALD, and partitioning significantly reduces the volume and surface area of the ALD environment. Thus, this partitioned architecture is the enabling feature for performing in situ STM studies of ALD.

For the highest resolution STM images obtainable with this tool, high vacuum (1×10⁻⁶ Torr) is maintained in the lower chamber with an ion pump only. Rotary and turbomolecular pumps are switched off, and all vacuum hoses are disconnected from the chamber. This provides a low-vibration, high vacuum environment. The system is non-load-locked for simplicity and accessibility, and high-resolution STM images can be taken in high vacuum and high-resolution mode 1.5 h after loading a sample. The typical pressure in this mode is 0.5-1×10⁻⁶ Torr, for example.

The ALD subsystem is a warm-wall, viscous-flow reactor. The vacuum chamber is made of 316L austenitic stainless steel for maximum corrosion resistance. The chamber walls are heated to 60° C., and the sample can be heated to 200° C. The heating is accomplished with electrical heating tape situated on the outside of the vacuum chamber. To minimize effects on the tunneling current, all heaters are powered by a dc current source.

Deposition is performed at a pressure of 3×10⁻¹ Torr with argon flowing as a carrier gas. The precursors are removed from the chamber with a rotary vane pump which operates continuously during deposition. Two zeolite traps are used to capture precursor vapor before entering the pump and to prevent backstreaming of hydrocarbons from the pump into the deposition environment.

The precursors are located in vials below the vacuum chamber and are dosed into the chamber by momentarily opening pneumatic diaphragm valves. The STM system has sufficient stability that the diaphragm valves can be cycled while tunneling, without the tip crashing into the sample. The precursors are conducted directly to the tip-sample junction through polytetrafluoroethylene tubing. Control of the valves and measurement of the pressure is accomplished with commercial automation devices and custom-written software.

In one embodiment, the STM is based on a commercially available Agilent 5500 scanning probe microscope (SPM), which utilizes a pendulum-type, tip-scanning piezo system. In the Agilent scanner, a tubular piezo element is used for scanning in the Z-direction, and pairs of bar piezo elements are used for scanning in the X and Y-directions. All the piezo elements are housed inside a cylindrical scanner body, and the tip projects downward from the bottom of the scanner. The scanner body is constructed of 303 stainless steel. The proportional-integral feedback control and the piezo high voltage amplification are accomplished by an Agilent digital SPM controller, with the interface to the controller, including image acquisition, performed by Agilent's proprietary PicoView software. The approach is performed by three stepper motors driving vertically mounted plungers, which magnetically support the sample stage. The base of the commercial microscope was replaced with a custom-designed base which was integral to the vacuum system described above. This custom base and tip-scanning configuration allows the vacuum chamber to be partitioned, with only the scanner and plungers penetrating the partition, as shown in FIG. 2.

The Agilent scanner housing contains fully integrated electronics and optics for operation in AFM mode in addition to STM. In order to switch between these two modes, one needs only to replace the STM tip nose cone with the provided AFM cantilever nose cone. This functionality allows the instrument to operate on electrically insulating samples, although the routinely achievable spatial resolution in AFM mode is lower than in STM mode.

A number of customized components add additional capability. Coarse X and Y translation of the sample over a 7 mm range is accomplished with commercially available stepper motors mounted on vacuum feedthroughs. The X and Y actuators are disengaged from the sample during imaging by utilizing backlash intentionally added to the actuation system. This prevents thermal expansion and vibration in the actuators from causing drift and noise in the images.

A bias voltage is applied to the sample, and the tunneling current is measured by a transimpedance amplifier connected to the tip and located immediately outside the vacuum chamber. The amplifier can be disconnected from the system and the tip connected to a high voltage power supply, enabling field emission, which may be used to sharpen and clean the tip after ALD. Fourteen additional electrical leads are available, which allow for future expansion to in situ device characterization and techniques such as scanning tunneling potentiometry.

Optical access to the tip-sample junction is provided through four paths. Two are directed from the side, and impinge on the sample at a 12° grazing angle. One path is provided through the Agilent scanner and impinges on the tip-sample junction from the top at an angle normal to the sample. The fourth path impinges on the junction from below and is also normal to the sample. If the sample is not transparent, the utility of this optical path is limited to functions such as providing general lighting in the deposition chamber.

The tunnel junction is shielded from ambient electromagnetic radiation by the 19 mm thick walls of the vacuum chamber. These thick walls and the vacuum chamber's large mass (180 kg) also thermally buffer the microscope so that it is relatively insensitive to temperature fluctuations. With diurnal fluctuations in the ambient temperature of ±0.5° C., the junction is stable in open loop for 10 s, enough time to perform scanning tunneling spectroscopy measurements.

Furthermore, the measurement loop is small, limiting the effects of vibration and thermal expansion on the tunnel junction. The effectiveness of this is demonstrated by the absence of a tip crash when the diaphragm valves are opened while tunneling.

STM's are highly sensitive to vibration due to the exponential dependence of the tunneling current on distance and the very small gap between the tip and sample, typically less than 1 nm. Excitations which affect the STM can be classified in two categories: seismic excitations which are ambient vibrations transmitted through the ground, and acoustic excitations which are vibrations transmitted through sound waves in the air. A custom passive seismic and acoustic isolation system was used, which is described below.

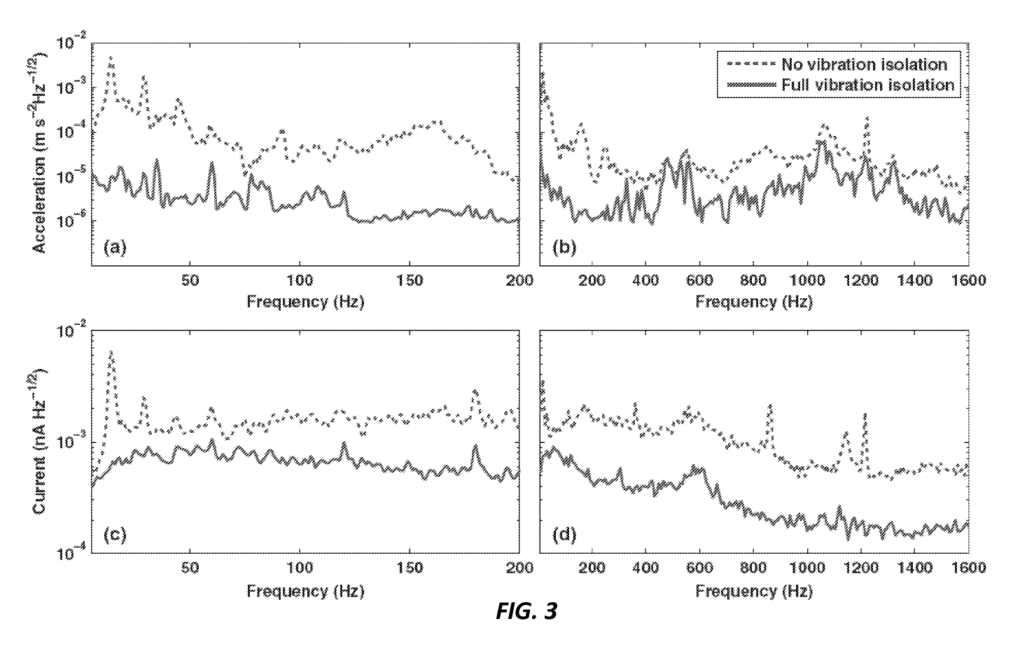

The microscope is isolated from seismic vibrations (typically resulting from ambient floor vibrations) with a granite bungee suspension system. The vacuum chamber enclosing the STM rests on a 90 kg granite block. The granite is suspended by eight rubber bungee cords with a diameter of 15.9 mm. The combined mass of the vacuum chamber and the granite is 270 kg, resulting in a mass-spring system with a natural frequency of 1.5 Hz. The good damping properties of granite combined with the low natural frequency of the suspension system result in excellent isolation from low-frequency seismic excitations, as seen in FIG. 3(a) and FIG. 3(c). For in situ imaging of ALD, a 35 kg mass attached to the rough vacuum hose serves to substantially isolate the STM from the operating roughing pump.

The acoustic isolation chamber was designed specifically for this system and uses the “room-within-a-room” technique, the best known method for acoustic noise control. Measuring 1.4 m×1.4 m×1.8 m, it includes two concentric, mechanically decoupled boxes that surround the microscope system.

The outer walls, supported by a welded aluminum frame, are made of two layers of 19 mm thick medium density fiberboard glued together with a vibration dampening compound. They are bolted to the frame and sealed with neoprene foam tape. The inner box is separated from the outer one by a 7.6 cm air gap and connected to it only by a set of rubber isolation pucks at the base. Its walls are made of three layers of 12.7 mm drywall glued together with the same dampening compound and are bolted onto a stand-alone steel frame using neoprene foam as a sealant.

The inner surfaces of all walls are covered with acoustic foam to prevent reverberation. Each wall is removable for complete access to the system and has a mass of 50 kg, as mass is the most effective mechanism for blocking sound. Both boxes sit on sets of seismically isolating rubber pucks to help damp vibrations from the ground. The walls contain sealable feedthroughs for all electrical and vacuum lines that must be brought outside.

The acoustic chamber is effective in isolating the STM from higher frequency acoustic excitations, as shown in FIGS. 3(b) and 3(d). With all four walls of the chamber closed, noisy ambient conditions such as nearby conversation, rolling chairs, or music at moderate volumes are not seen to affect the tunneling current. Combined with the seismic isolation described above, the system yields a broad spectrum current noise floor of less than 1 pA*Hz^{(-1/2)}. This isolation scheme has been duplicated in our laboratory for another SPM instrument, with similar effectiveness.

FIGS. 3(a)-3(d) show vibration and tunneling current noise spectra. FIGS. 3(a)-(b) show vibration spectra as measured by a piezoelectric accelerometer resting on the granite block next to the chamber. Data are shown for low FIG. 3(a) and high FIG. (b) frequency ranges. FIGS. 3(c)-3(d) show stationary STM current noise measured at room temperature using a tunneling current of 1 nA and bias of 0.3 V, with PI gains turned down to 1% to remove effects of the control loop. All plots show data with the vibration isolation system fully disabled (dashed curves) and fully enabled (solid curves). Significant noise suppression is seen across the measured range including elimination of most resonance peaks. These data were recorded in quiet ambient room conditions; noisier conditions raise the dashed curves significantly, while not discernably affecting the solid curves.

In the following example, the performance of the ALD system was demonstrated by growth of zinc sulfide thin films on gold substrates. The precursor used for zinc deposition was diethylzinc, and hydrogen sulfide was used as a sulfur source. The reactor design and experimental conditions utilized previously published techniques for ALD of zinc sulfide. Hydrogen sulfide was generated in situ by the decomposition of thioacetamide, which produces hydrogen sulfide and acetonitrile. No nitrogen was detected in the film, which is consistent with prior descriptions of the technique. A carrier gas flow of 20 standard cubic centimeters per minute of Ar was used to assist in precursor transport and purging. The reactor is a flow-type reactor, and is continuously pumped during deposition.

A purge time of 60 s was used between precursor and oxidant pulses. The chamber pressure during deposition was 3×10⁻¹ Torr, due to the Ar flow. The chamber walls were heated to 60° C., and the sample was at a temperature of 160° C.

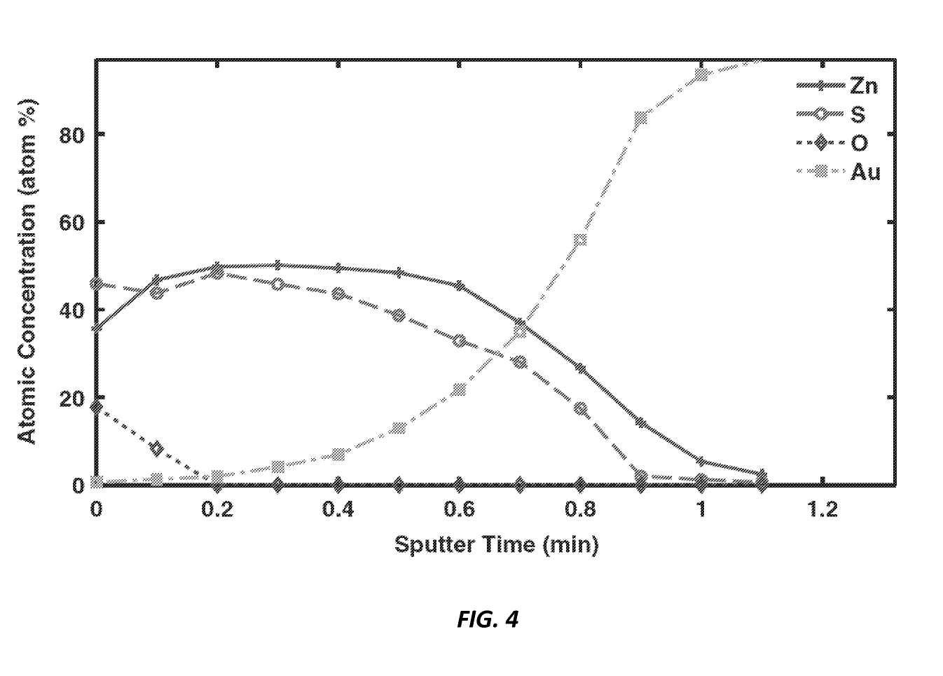

X-ray photoelectron spectroscopy (XPS) performed ex situ was used to characterize the ALD films (FIG. 4). Although there is some variation from the ideal 1:1 Zn:S stoichiometry, the film is mostly composed of Zn and S, and contains no oxygen except for surface oxidation. Heating the chamber walls to 60° C. during deposition was necessary to eliminate oxygen from the films. The growth rate for this chemistry in one embodiment of the instrument ranges from 0.5 to 1 Å/cycle at a substrate temperature of 160° C., in agreement with previous work. This agreement indicates that our purge time is sufficient for ALD and that the growth is self-limiting.

The variability of the growth rate below 1 Å/cycle may indicate sub-saturated growth, which, although undesirable in typical ALD applications, is useful for the current example experiment.

The performance of the STM was validated on two substrates: cleaved highly ordered pyrolytic graphite (HOPG) and a gold(111) surface after hydrogen flame annealing.

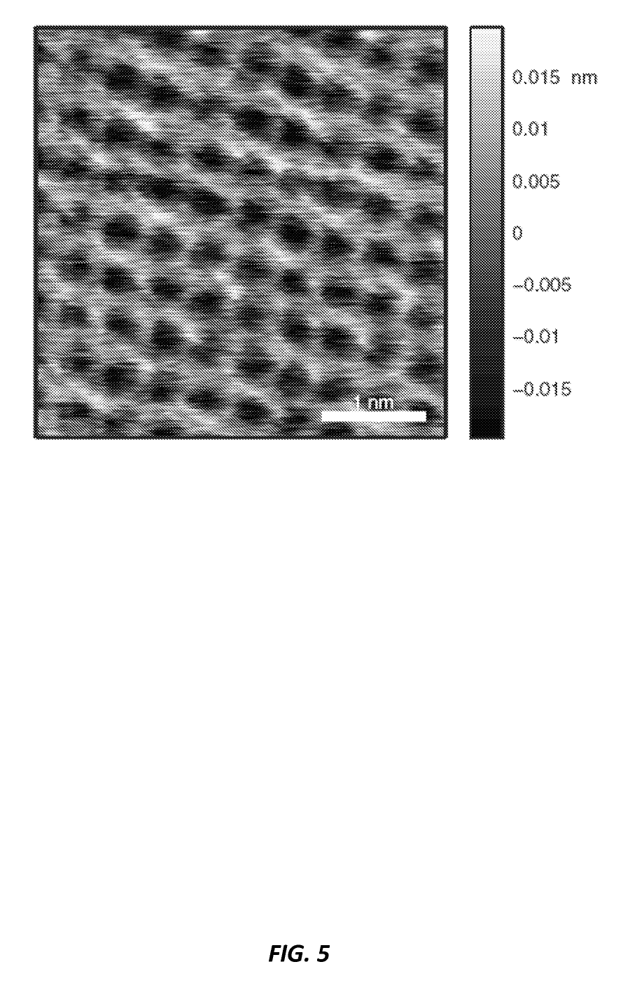

Atomic resolution was demonstrated on a commercially available freshly cleaved HOPG surface, as shown in FIG. 5. For this and all images shown in this paper, mechanically cut Pt/Ir wire was used as a tip. For this measurement, the full acoustic and seismic isolation system was used. The image was taken at a chamber pressure of 2×10⁻² Torr with no vacuum pumps operating.

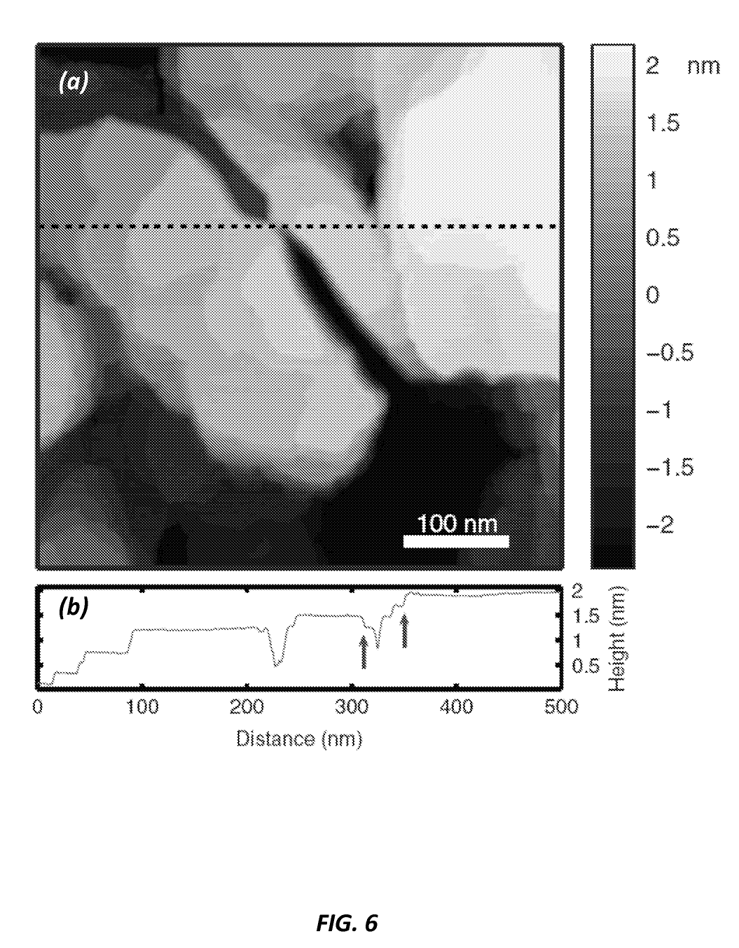

The noise performance of the STM-ALD tool was further tested on a commercially available gold(111) surface freshly cleaned with hydrogen flame annealing. As shown in FIGS. 6a-6b, atomic steps can be clearly resolved, and corrugations from noise are less than 20 pm.

STS is a technique for measuring the local density-of states (LDOS) of features on a sample using STM. Spectroscopy in the STM-ALD tool is typically performed by opening the feedback loop, repeatedly sweeping the sample bias across the desired range, and averaging the current response. The I(V) data is then numerically differentiated to obtain a differential conductivity (dI/dV) spectrum, which is representative of the LDOS.

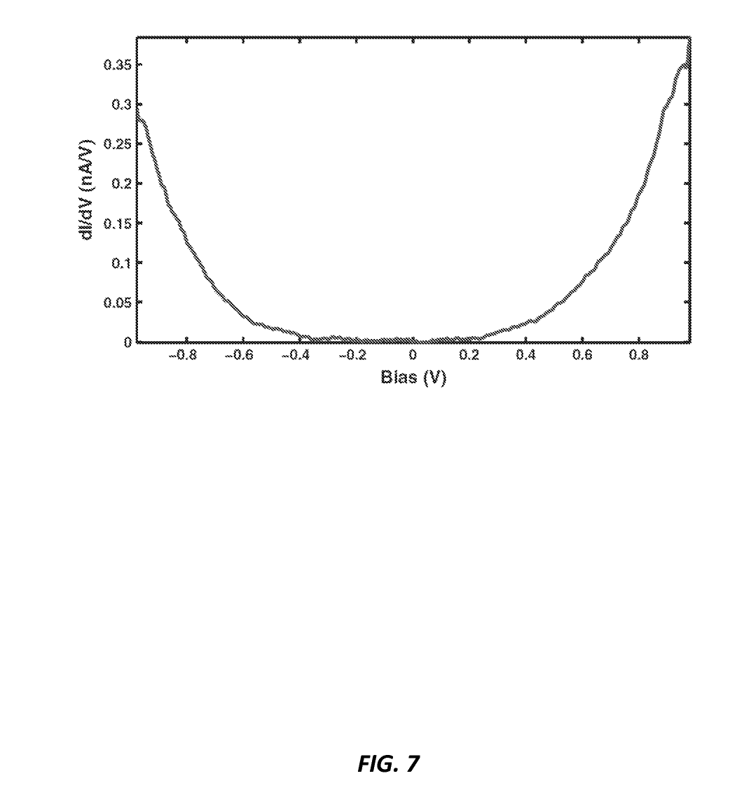

FIG. 7 shows such a dI/dV(V) spectrum recorded on a 30 nm thick PbS thin film grown by 500 cycles of ALD in a separate reactor. From this curve, it can be observed that the band gap is ˜0.5 eV, and the position of the Fermi energy is ˜0.2 eV below the conduction band edge, indicating slight n-type behavior. This band gap value matches similar measurements on other PbS thin films.

Spectra can also be measured in the system using the common lock-in technique of lightly modulating the sample bias and extracting the response of the current at the same frequency. Because this technique requires the feedback loop to be held open significantly longer than the numerical technique does, its use is limited to cases in which tip-sample drift is particularly small and the tunnel junction is particularly stable.

Since most ALD processes occur at elevated temperatures, the ability to perform hot STM is necessary for obtaining in situ images. Attention to detail is essential in three areas: electrical noise, temperature stability, and tip expansion.

First, coupling of electrical noise from heating elements into the tunneling current must not occur. Our instrument uses dc power for electrical heaters and careful grounding to minimize this effect. As a result, no additional noise in the tunneling current spectrum is observed when the chamber is heated to 60° C. and the sample is heated to 160° C.

Second, stable temperature control of the sample is crucial, as the sample holder exhibits a temperature sensitivity in the Z direction of 14 nm/° C. With proper (sufficiently low) controller gain settings, the sample temperature is stable to better than the 0.1° C. resolution of the temperature sensor and controller used, resulting in the absence of observable Z direction drift attributable to temperature fluctuation.

Third, tip expansion strongly affects the measurements. While the tip is within tunneling distance of the hot sample, a thermal equilibrium between the two is reached with the tip relatively warm. When the tip is retracted just a few hundred nanometers, it cools significantly. When the tip is brought back to within tunneling distance and a constant tunneling current is maintained, it goes through an expansion process, which can be observed in a trace of the Z piezo position. In this example embodiment, a wait of ˜5 min is required for thermal equilibrium to be re-established and sufficient stability obtained for imaging.

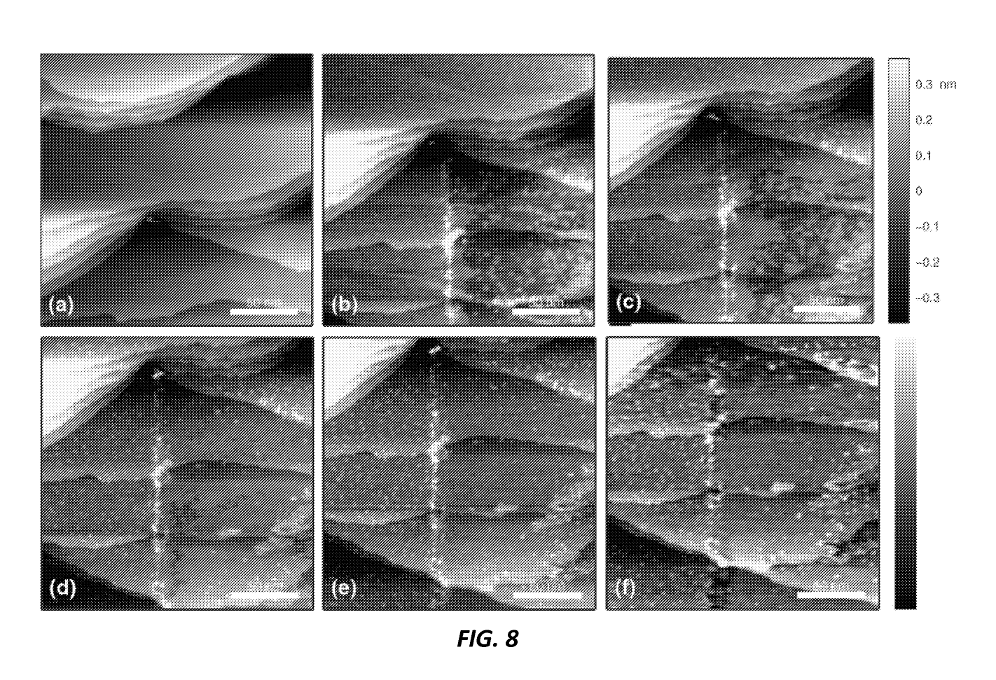

The utility of the tool is realized when the techniques of STM and ALD are combined to obtain in situ images of the deposition process. As a demonstration case, a modified room-temperature deposition process for ZnS was performed on the Au(111) surface prepared as described above, and images were taken after each cycle of precursor and oxidant (FIGS. 8a-8f). This experiment demonstrates the capability of the instrument to image the results of individual adsorption cycles, while avoiding actual ALD growth. STM images of ALD deposition at elevated temperature have also been observed with the instrument, and will be reported elsewhere.

The experiment was performed under standard conditions of ALD, except that argon carrier gas was not used and the sample and the chamber were at room temperature, well below the temperature window in which ALD proceeds for ZnS. The rotary vane pump was operating and connected to the chamber with a stainless steel vacuum hose. For ease of access during initial deposition testing, the instrument was not suspended on the bungees but resting on its support frame, and the walls of the acoustic chamber were not attached. Even without the primary isolation systems operating, the inherent mechanical stability of this STM is such that the nanometerscale deposited features can easily be resolved.

For each cycle of deposition, the STM tip was retracted ˜500 nm and the precursors sequentially introduced and removed from the deposition environment. Sixty seconds of pumping time was used after each pulse of precursor. After pumping of the precursors was completed, the tip was brought to within tunneling distance of the sample and a constant current topograph was taken of the resulting deposition.

As the sample was at room temperature during the deposition, the observed changes as a function cycle number in FIGS. 8(a)-8(f) may be attributed to physisorption of one of the precursor species. Nonetheless, these images demonstrate the ability of the instrument to observe nucleation and initial growth of thin films cycle-by-cycle. Individual features may be tracked from cycle to cycle, and the relative rates of deposition on terrace edges and defects may be observed and compared. Observations of phenomena such as the mobility of the adsorbates in FIGS. 8(c)-8(d) are enabled. This feature tracking is possible since the tip is retracted by only a few hundred nanometers with the scanning piezo, not with the approach mechanism.

Maintaining the cleanliness of the STM tip during deposition is an issue, as tip contamination can significantly affect image quality. Indications of tip contamination include streaking in images, repeated features, and excessive noise in the tunneling current. According to the current invention, tip contamination either does not occur or does not compromise image quality. Because a corrupted image is easily distinguishable from a clean one, it seems that tip contamination from ALD precursors simply reduces experimental yield, rather than reducing data quality or preventing experiments altogether. If there is an upper limit to the number of ALD cycles, which a tip can sustain before becoming corrupted, the example experiments indicate it to be greater than ˜15 cycles. This is sufficient for studying the nucleation of ALD and for fabricating ultra-thin nanostructures. In addition, in the cases when tip contamination that cannot be removed with field emission prevents completion of an experiment, the high-throughput design of the instrument allows for the starting of a new experiment with a fresh tip and sample in approximately one hour.

Below is described in situ topographical observations of film growth during the initial cycles of atomic layer deposition (ALD) using scanning tunneling microscopy (STM), according to one embodiment of the invention. Presented are cycle-by-cycle STM topographs of zinc sulfide films during ALD on Au(111) surfaces, tracking individual grains, 5 nm in diameter, as they grow over tens of cycles. The findings show that grain morphology is temperature-dependent and grain size increases with deposition temperature from 100° C. to 160° C.

Atomic layer deposition (ALD) is a sequential, self-limiting vapor deposition technique, which yields angstrom-scale control over film thickness and composition. ALD has rapidly gained adoption in deposition of high-permittivity dielectric materials, catalysts, high-aspect-ratio structures, and fuel cell electrolytes, primarily for its ability to conformally grow ultra-thin, very dense films.

Many ALD processes begin with a nucleation stage, in which islands form and grow. After a variable number of cycles, which is governed by the precursor-surface chemistry, the islands coalesce into a continuous film. Whether this island-type growth mechanism is beneficial depends on the application. For most devices, continuous thin films are required, so the non-uniformity caused by nucleation negatively affects film performance. For some applications, though, this nucleation can be used to conformally coat surfaces with nanoparticles. Regardless of the application, understanding the initial growth is key to developing ALD processes for the thinnest of films; for films that are only several nanometers thick, the nucleation stage of ALD comprises the entire growth process.

Disclosed here are the first in situ, nanometer-scale topographical observations of the initial cycles of ALD using a custom instrument that integrates an Agilent 5500 scanning tunneling microscope (STM) with a homebuilt ALD system. Observed are the nucleation and growth of individual grains, and have observed a temperature dependence on the evolution of grain morphology in the early stages of ALD.

Disclosed herein are measurements of ALD growth of zinc sulfide on Au(111) substrates, according to an example embodiment of the invention. ZnS, a wide bandgap semiconductor, is of interest in thin-film photovoltaics as its optoelectronic properties and non-toxicity make it a candidate for buffer layers in Cu(In,Ga)Se₂ (CIGS) solar cells. Gold substrates were used because of their ability to be prepared into an atomically flat and clean surface suitable for high-resolution STM imaging without preparation in ultra-high vacuum, and because of gold's affinity to thiols.

Standard parameters were used for the ALD of ZnS. Diethylzinc (DEZ) was used as the zinc source, and H₂S resulting from the decomposition of thioacetamide (TAA) was used as the sulfur source. Pulse times of 150 ms and 50 ms were used for DEZ and H₂S, respectively, and a purge time of 60 s was used after each pulse of reactant. The reactor was continuously pumped during deposition and has a base pressure of 1×10⁻³ Torr. To aid in precursor delivery and purging, a constant argon gas flow of 20 standard cubic centimeters per minute was used, bringing the deposition pressure to 3×10⁻¹ Torr. The walls of the deposition chamber were heated to 60° C., and the sample temperature was varied from 25° C. to 160° C. All deposition was performed on commercially available Au(111) surfaces cleaned by butane flame annealing immediately before insertion into the deposition chamber. The growth rates that were observed from this process are similar in magnitude to other studies on the H₂S/DEZ system. All STM images shown in this letter were acquired under the same conditions, except for sample and chamber temperature. The mechanical roughing pump remained in operation during imaging. An electrical bias was applied to the sample, and the tunneling current was measured at the tip, which was prepared by cutting Pt_{0.8}/Ir_{0.2} wire. During precursor pulses, the tip was retracted to the top of the piezo range, typically 700 nm above the sample. An image was then acquired after each H₂S/DEZ cycle of ALD. All images were acquired at the process temperature, which ranged from room temperature to 160° C.

In these experiments, deposition can occur on the STM tip as well as the sample, and can impact image quality. Fortunately, due to the nature of STM, only the atom at the apex of the tip contributes significantly to the tunneling current. While the tip remains sharp, stable, and conductive, it is usable for acquiring topographs. Under most conditions, the tip remains usable for 15-25 cycles, long enough to study the nucleation phase of ALD. As the semiconducting film grows thicker, however, the tip moves closer to the film surface to maintain the tunneling current, eventually touching it and preventing further imaging.

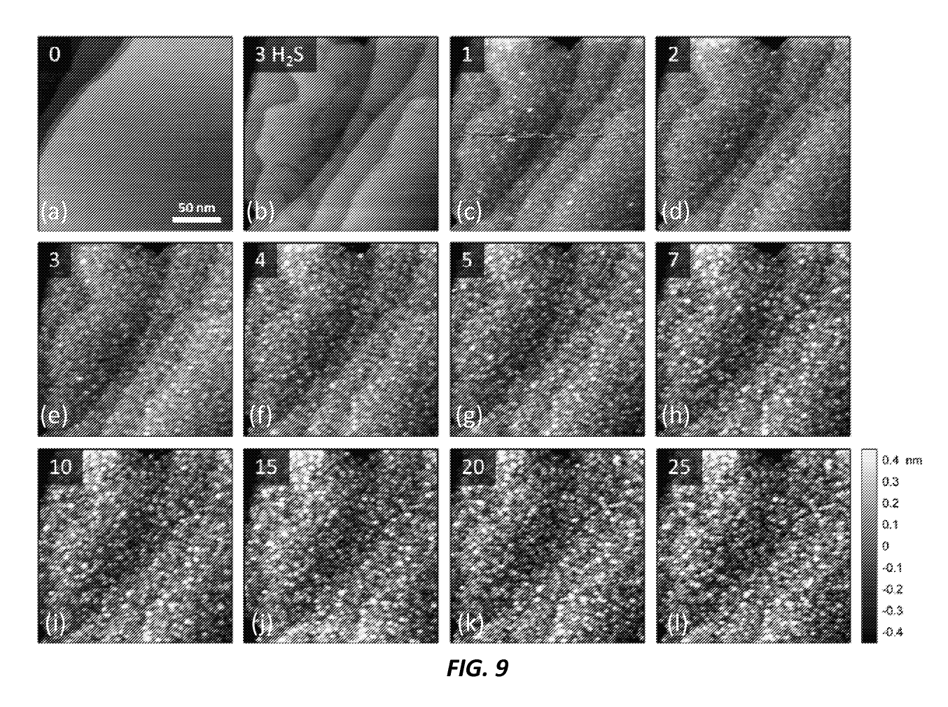

FIGS. 9(a)-9(l) show an example of grain nucleation and growth over the first 25 cycles of ZnS ALD at 160° C. In this case, the gold surface was etched upon exposure to H₂S. This occurred in most cases above room temperature, with no discernible effect on the subsequent deposition. The supporting information contains discussion on the etching phenomenon. When DEZ was introduced, unconnected islands approximately 5 nm in diameter and a few Angstroms in height nucleated over a period of two or three cycles before coalescing into a continuous film. The islands were flat, with heights only 2-5% of the diameters. After full coverage was established, grain diameters grew slightly and corrugation in height increased. This sample was representative of the others in this study. The growth rate was measured by depth profiling with x-ray photoelectron spectroscopy (XPS) to be 1.7 Å/cycle at 160° C., and transmission electron microscopy (TEM) shows that the films are nanocrystalline at 100° C., 130° C., and 160° C., with both wurtzite and zincblende phases present. XPS and TEM results are included in the supporting information.

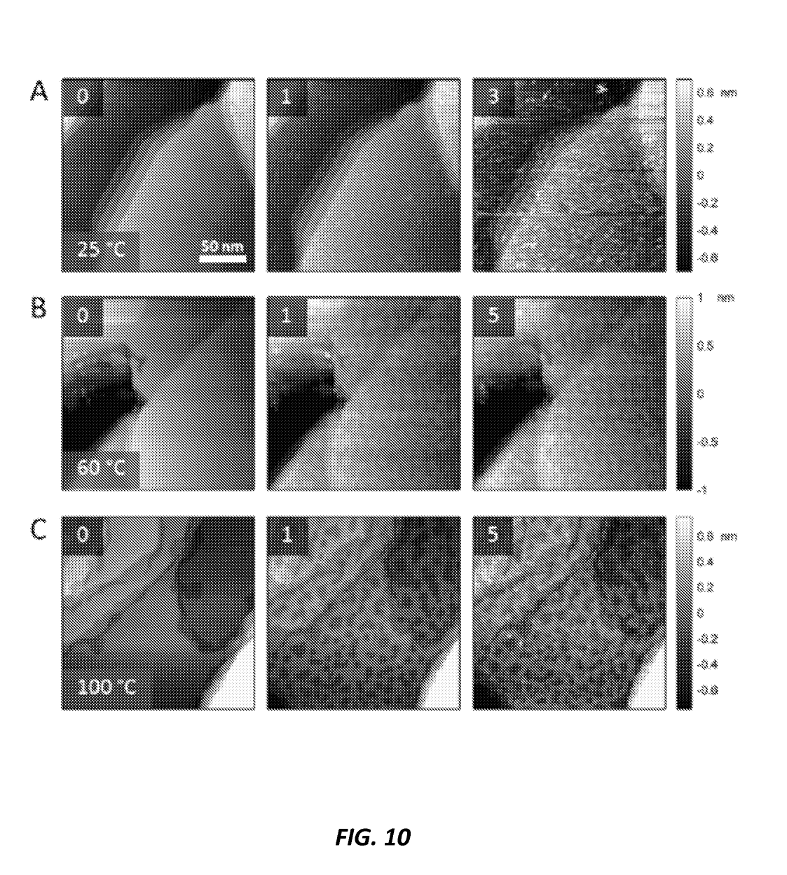

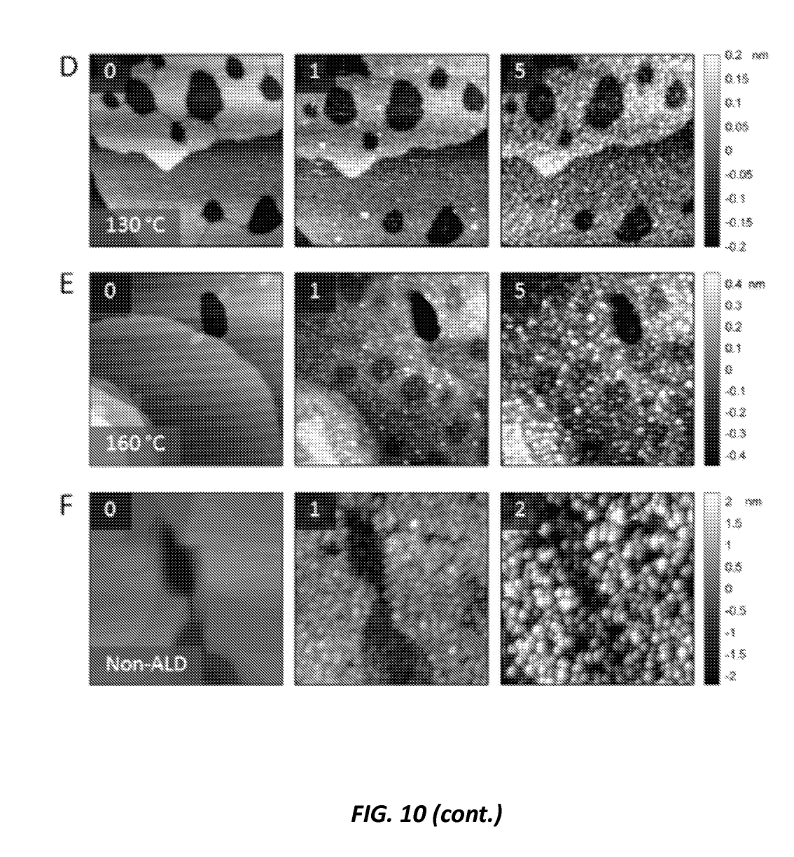

Growth in the initial cycles of ALD can be controlled by environmental conditions such as temperature and background gas composition. FIGS. 10(a)-10(f) show the effects of several environmental conditions in different experiments. FIG. 10(a) shows physisorption of precursor molecules at room temperature, below the ALD growth window of the H₂S/DEZ chemistry. Unable to react chemically with the substrate, the precursor molecules remained mobile on the surface. By the third cycle, the tip was dragging and dropping clusters of the accumulated precursor, and by the fourth cycle, imaging was not possible. In FIGS. 10(b)-10(e), chemical deposition reactions occurred at temperatures from 60° C. to 160° C., and an increase in grain size was observed with increasing temperature. In FIG. 10(f), ZnO was grown through a non-self-limited, non-ALD mechanism, due to O₂ contamination of the constantly-flowing Ar carrier gas. This uncontrolled growth was much faster and produced much larger grains than the ALD growth shown in the other panes.

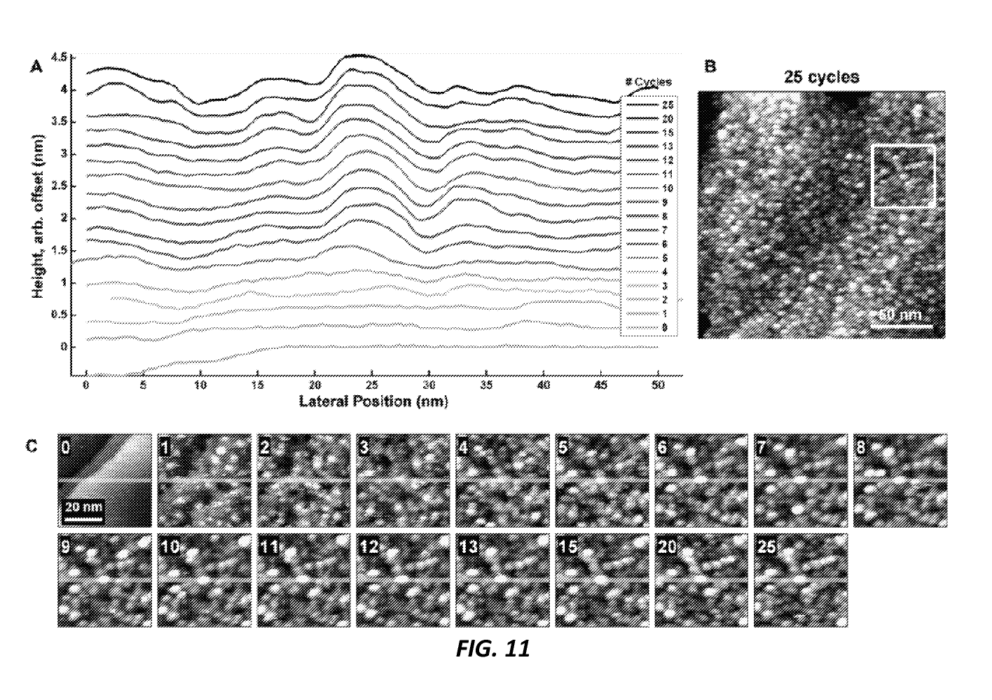

FIGS. 11(a)-11(c) contain cross-sectional STM profiles showing individual grain growth over 25 cycles. Surface corrugation increases with cycle number, from atomically flat terraces before deposition to a peak-to-trough height of 7 Å after 25 cycles. Furthermore, the shape and position of the grains are not well-defined until a threshold cycle, after which more uniform layer-by-layer growth occurs.

This threshold cycle often varies between grains on the same sample. While some grains assume their final morphology after the 2nd or 3rd cycle, the center grain in these figures do not reach final morphology until the 7th cycle, and the grain at the left edge of the cross-section only begins to form at the 20th cycle.

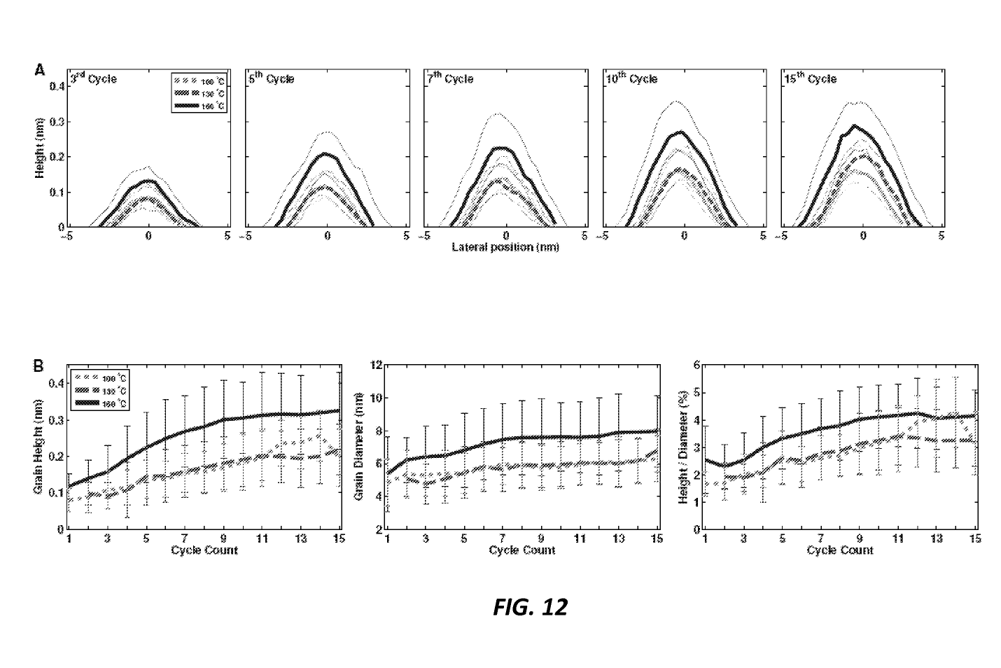

In FIGS. 12(a)-121(b), quantitative analysis of cross-sectional profiles such as those in FIGS. 11(a)-11(c). FIG. 12(a) shows a statistical representation of grain profiles at three temperatures, taken from measurements on 140 grains across seven samples. These measurements reflect surface corrugation, which increases steadily through cycle 10 and then gradually through cycle 15. FIG. 12(b) shows cycle-by-cycle mean statistics, which indicate that grain height increases through cycle 10 and is approximately constant through cycle 15, while grain diameter levels off after cycle 7. Twenty grains were measured on each sample, and the same grains were measured after each cycle. Thus, this data conveys aggregated information about individual grain growth from cycle to cycle. The same data, but averaged by sample instead of by temperature, is shown in the supporting information.

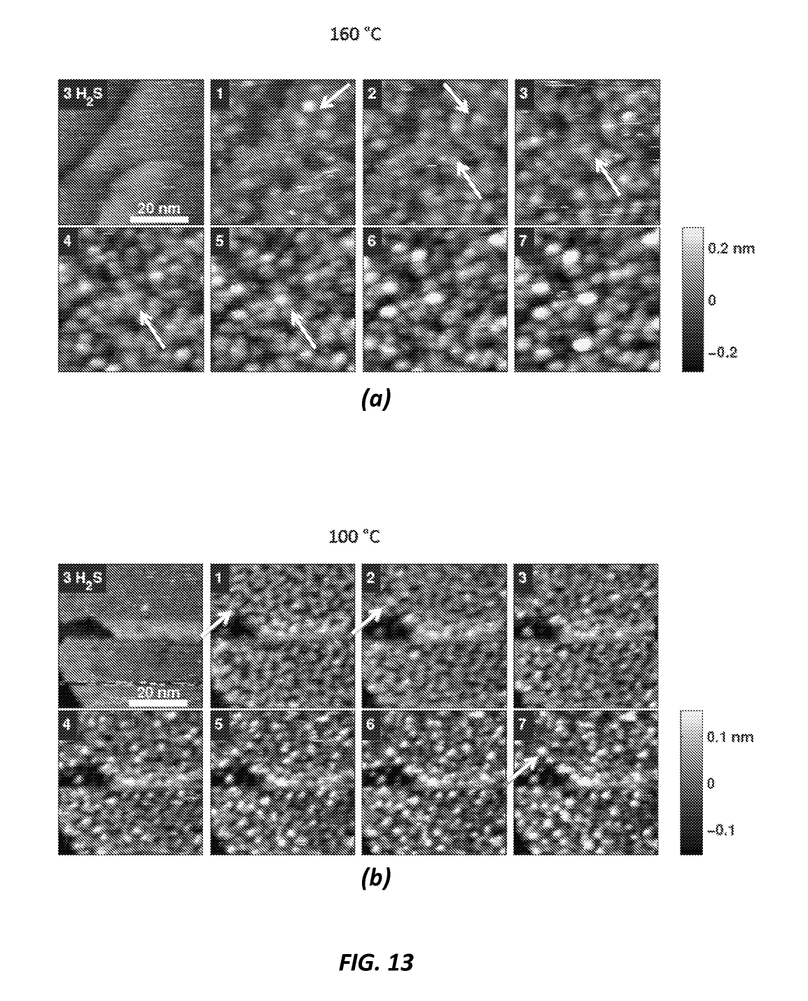

The data further indicates that grains grown at 160° C. in this system are larger in both height and diameter than grains grown at 130° C. and 100° C., which have quite similar characteristics. The correlation between grain size and deposition temperature suggests that diffusion may contribute to this difference. Mobility of surface species, as well as differential grain growth, can be seen in FIGS. 13(a)-13(b).

As shown in FIGS. 13(a)-13(b), the surface morphology at 160° C. undergoes rearrangement for several cycles before stabilizing in cycle 5. Only some grains visible at cycle 7 can be traced back to cycle 1. In contrast, the film deposited at 100° C. does not exhibit such rearrangement in the first few cycles, but rather has consistent morphology from cycles 1-7. The microstructure is easily recognizable from cycle to cycle. Given the correlation of rearrangement with surface temperature, surface diffusion of adsorbed precursor species may contribute to the differences in grain size.

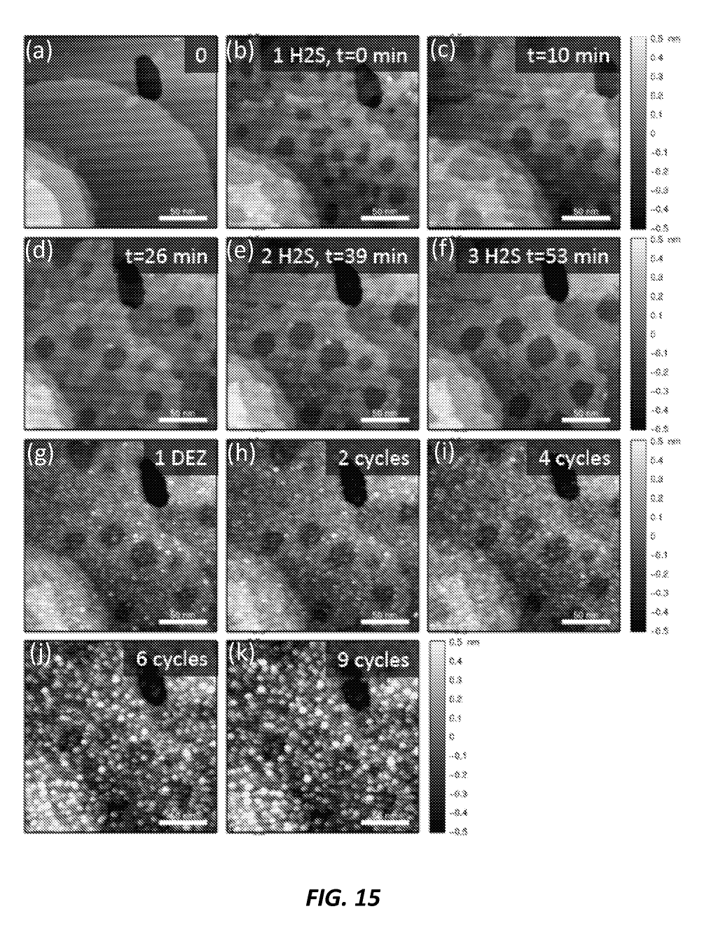

Distribution of the grain diameters in thin films is a critical property for many applications, such as optoelectronics and fuel cells. Whereas the measurements shown in FIGS. 12(a)-12(b) were aggregated over multiple samples grown on different days, FIGS. 15(a)-15(k) show grain size statistics for the DEZ/H₂S chemistry on a single sample (160° C.), better representing the grain distribution that might be expected in a given device. These measurements were performed on a larger number of grains than in the prior analysis, using a second method in which we manually selected grain perimeters using an image analysis software package and calculated an effective diameter from the enclosed area.

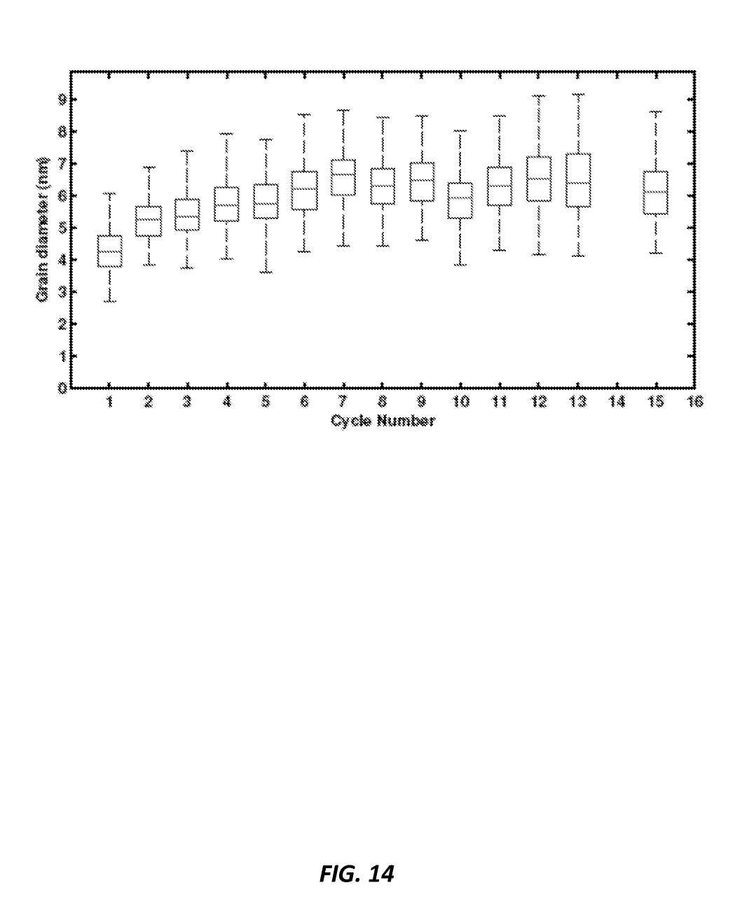

From this analysis it is observe that the middle 50% of grains on a single sample grown at 160° C. have a spread in diameter of just over 1 nm (˜20% of the median diameters), which remains relatively constant as a function of cycle number. The spread of the full distribution of grain sizes, indicated by the whiskers in FIG. 14, grows from 3 nm to 4 nm over the first several cycles, after which it also remains relatively constant. These observations are representative of our samples grown at 160° C. as a whole.

These examples demonstrate the first in situ nanometer-scale topographical observations of ALD by using STM. Single grains of ZnS are tracked as they nucleate, merge, and grow during the first 25 cycles of ALD at temperatures up to 160° C. Observations are provided for the DEZ/H2S/Au system that chemisorption of the ALD precursors occurs at temperatures from 60° C. to 160° C. The statistics of grain sizes are reported, observing that grain size depends on temperature, which are attributed to enhanced precursor mobility at higher temperatures. The current invention provides a better understanding of ALD nucleation for ultra-thin dielectrics and quantum dot layers.

The cases in which etching was observed have the following characteristics in common:
The surface stabilizes after 1-2 pulses of H2S and is not etched upon further exposure to H2S.
Etching does not occur after the first DEZ pulse. This appears to stabilize the surface.
The etching has a significantly different character than ZnS deposition. The etching shown in FIGS. 15(a)-(k) are typical in that the surface exhibits a mixture of etch pits and redeposited material.

This appearance is markedly different than the surface topography after one pulse of DEZ and the full H₂S/DEZ cycles thereafter, in which the surface is covered with rounded nanoscale grains. This qualitative difference in appearance indicates that the etching behavior is a distinctly different process from the growth behavior evident in later cycles.

The etching does not always occur, and examination of process parameters and substrate fabrication history does not reveal any correlation between our directly controlled parameters and the presence of etching. FIG. 10(d) above shows a sample not etched by H₂S. On this sample, visible pits were present before exposure to H₂S, and no new pits were created. In general, the etching does not appear to affect deposition. No difference in ZnS growth was observed between samples, which did and did not exhibit etching.

Several mechanisms for the etching are possible. One, since a DEZ pulse prevents further etching in all observed cases, it is likely that vapor-phase species are reacting with the gold surface, and the DEZ layer prevents these species from accessing the gold below. Another possible explanation is that the etching is catalyzed by a trace contaminant species on the Au surface. The observed surface stabilization after one or two cycles of H₂S is consistent with a surface species being consumed. Finally, in one embodiment of the deposition tool, the H₂S is produced by decomposition of TAA into H₂S and CH₃CN (acetonitrile), and it is this mixture that is used as the H₂S source. While previous studies on this chemistry have shown that the acetonitrile is not incorporated into ZnS films, it is possible that the etching may be a result of formation of the dicyanoaurate anion, [Au(CN)₂]⁻.

Several methods were used to characterize the films grown in the STM-ALD instrument. Transmission electron microscopy (TEM) using a FEI Tecnai G2F20 X-TWIN microscope operated at 200 kV was used to determine the thickness and confirm crystallinity of the ZnS film. The film cross-sections, approximately 100 nm thick, were sliced using a ultramicrotome and immediately picked up with Cu grid.

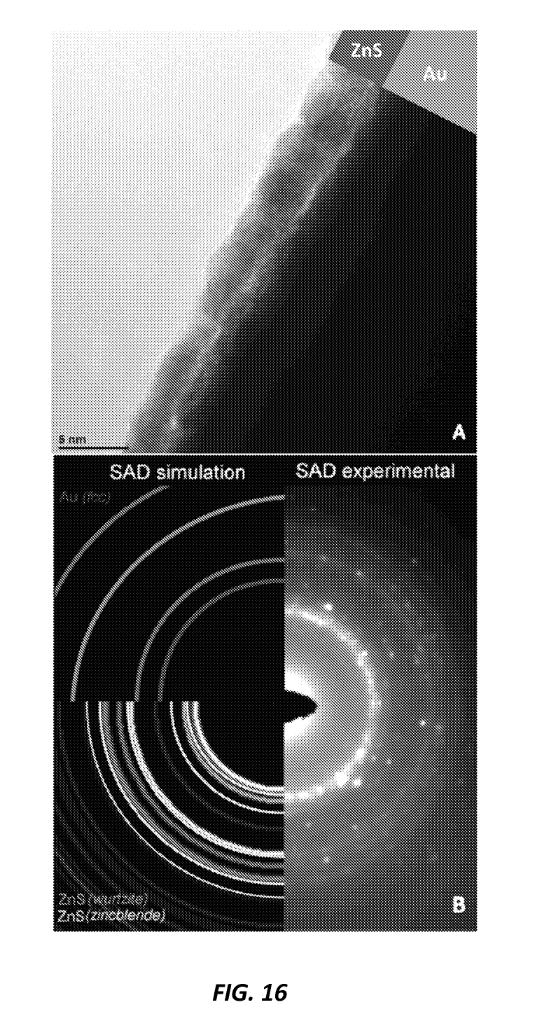

As shown in FIG. 16(a), the ZnS film is 4.2 nm thick with nanocrystalline grains. The selected area diffraction (SAD) ring pattern indicates random orientation of the ZnS crystallites. The crystal phase of the crystallites were determined by comparing the experimental SAD pattern with a calculated SAD pattern based on a ZnS wurtzite crystal structure (JCPDS 89-2942) with a unit cell a=3.818 Å and ZnS zincblende crystal structure (JCPDS 77-2100) with a unit cell a=5.414 Å. The SAD ring pattern simulation was calculated using JEMS software. The selected area diffraction (SAD) patterns in FIG. 16(b) indicate a mixture of wurtzite and zincblende phases in the ZnS film.

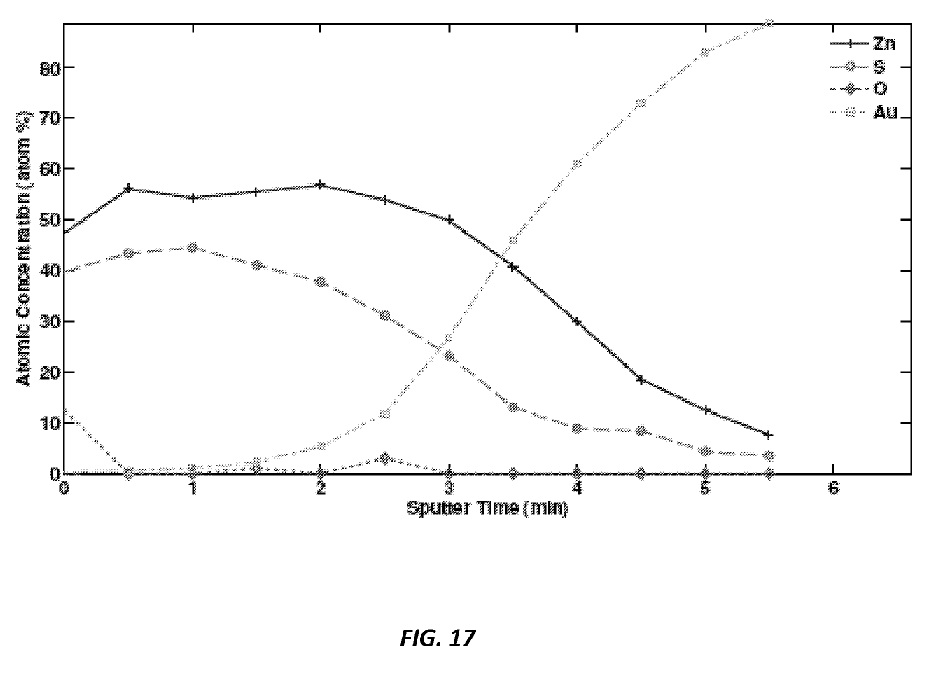

Every film in this example was checked for composition with x-ray photoelectron spectroscopy (XPS) depth profiling, using a PHI Versaprobe Scanning XPS Microprobe with Al(Ka) radiation at 1486 eV. A representative example of an XPS depth profile is shown in FIG. 17. Depth profiling was performed by using Ar ion sputtering to successively remove layers of the deposited film. The film contains no oxygen (the primary contaminant in rough vacuum systems) except for ex situ surface oxidation. The apparent non-stoiochiometry is due to the Au signal's interference with the S calibration factor. This was always observed in this XPS instrument at Au—ZnS interfaces. The effect appears artificially significant here due to the thin film. Observations of crystal structure by TEM (FIGS. 16(a)-16(b)) provide supporting evidence that the film is stoichiometric.

Furthermore, the XPS data were used to estimate film thicknesses by comparing the depth profiles to a known sputter rate, which was obtained by sputtering through a ZnS film of known thickness. This technique is particularly useful since other methods of measuring thickness such as X-ray reflectivity and ellipsometry are unreliable on these substrates, due to their small size and the polycrystalline gold layer beneath the thin ZnS films. However, the XPS technique has limitations.

Zinc and sulfur are etched at different rates, and the sulfur composition is incorrectly reported due to the previously discussed interference from the Au signal. Furthermore, the sputtering rate of the XPS depends on the age of the filament and pressure of the Ar source. Due to these inconsistencies, XPS depth profiling is limited to providing estimates of the thickness and growth rate.

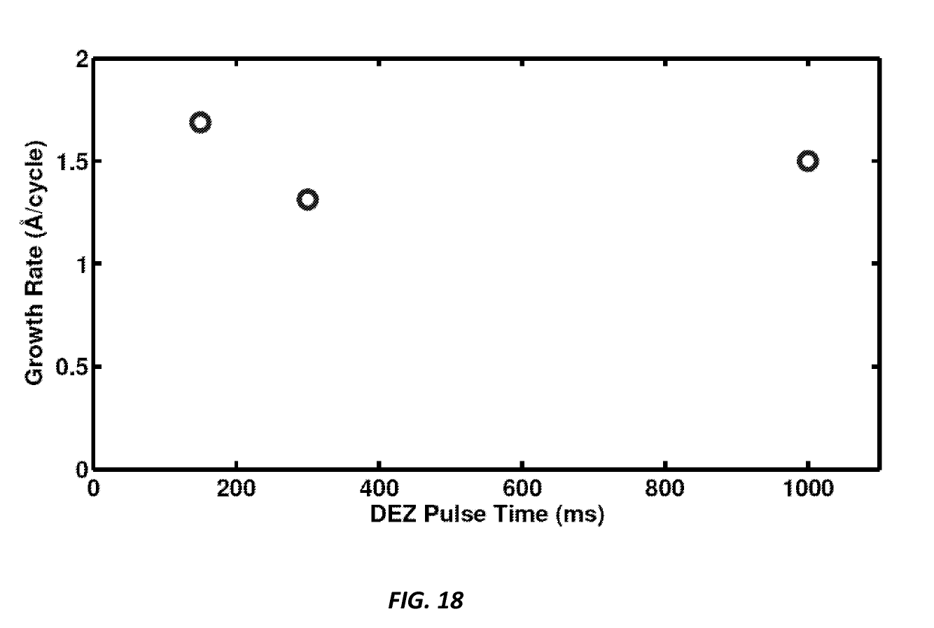

To check the self-limiting nature of the H₂S/DEZ reaction in our deposition tool, a dose saturation study was performed. The reactant dose was varied by changing reactant pulse times with all other variables held constant. For DEZ pulse times of 150, 300, and 1000 ms, the H₂S pulse times were 50, 100, and 500 ms, respectively. The three films were deposited with 50 cycles of H₂S/DEZ ALD at 160° C., and the thicknesses were measured with XPS depth profiling. As shown in FIG. 18, the ZnS growth rate does not depend on pulse time, confirming that the deposition is performed by an ALD process.

The resolution of the growth rate measurement on 50 cycle films is 0.2 Å/cycle, based on a sputtering increment of 0.5 min and an estimated sputter rate of 2 nm/min. The three data points shown in FIG. 18 are within two units of resolution of each other. Except for the data in the pulse saturation study, all of the ALD films shown in this letter and supporting information were grown with a DEZ pulse time of 150 ms and an H2S pulse time of 50 ms.

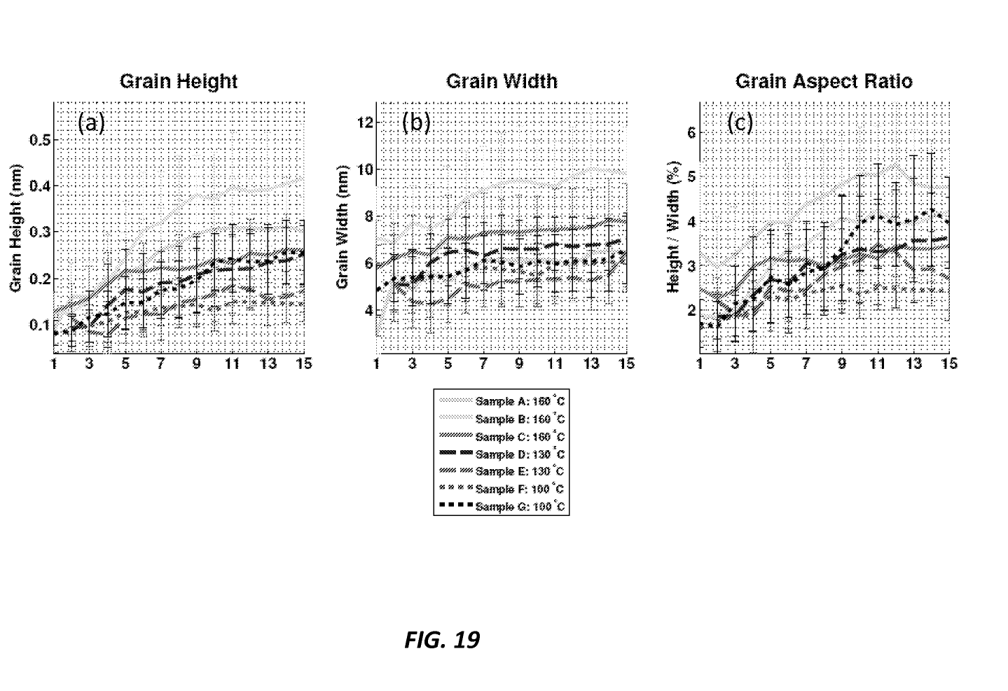

FIG. 12(b) above shows grain size data averaged by deposition temperature. To illustrate the variation in grain sizes from sample to sample, FIGS. 19(a)-19(c) show the same data, but averaged only by sample. The same grains were tracked and measured after each cycle. The samples exhibit some variation in height and diameter, but in general, grains grown at 160° C. exhibit larger heights and mostly larger diameters than grains grown at lower temperatures. Grains grown at 100° C. and 130° C. are indistinguishable within the confines of this analysis, given the limited number of samples.

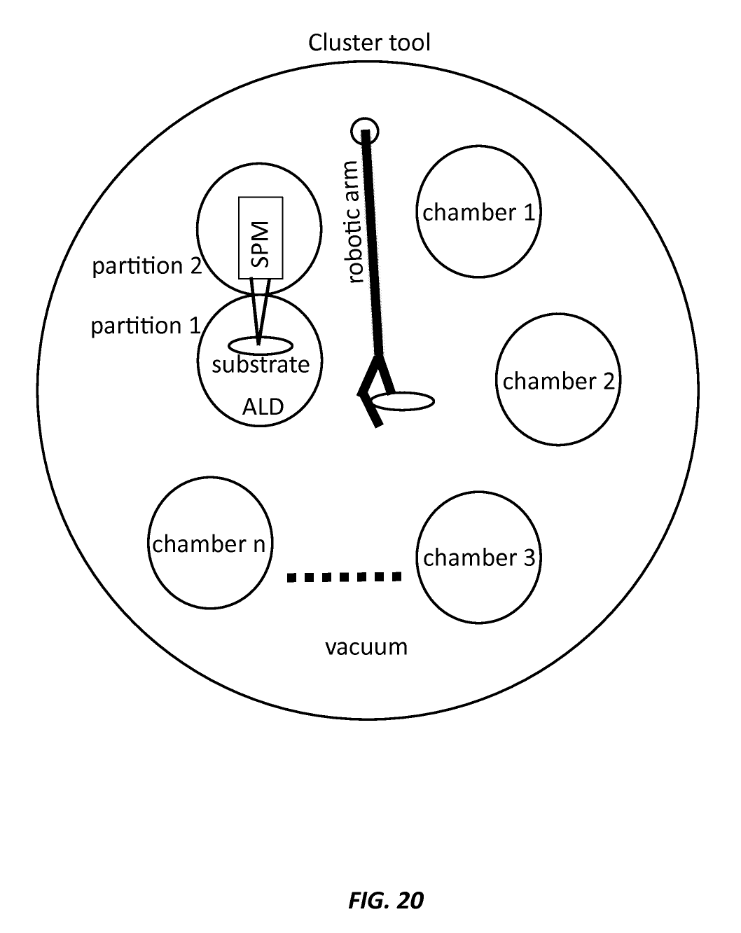

FIG. 20 shows a schematic diagram of the partitioned in situ monitoring tool integrated with a semiconductor processing cluster, where the substrate is moved by a mechanical transfer arm from the monitoring tool to other cluster chambers. According to one aspect, the monitoring of the semiconductor processes in situ includes using an apparatus with a second partition located above a first partition, where the second partition is hermetically isolated from the first partition, and a SPM probe tip of a SPM is disposed in the first partition, and remaining portion of the SPM is disposed in the second partition that is hermetically isolated from the first partition. As shown ALD process occurs in the first partition, where the ALD process includes a viscous-flow process utilizing sequential flow and purging of precursor and oxidant species to deposit a thin film. The semiconductor process can occur in any chamber in the cluster and can include deposition, etching, polishing, thermal, annealing, cleaning, liftoff, lithography, or implantation. deposition, etching, polishing, thermal, annealing, cleaning, liftoff, lithography, or implantation. In one aspect, the materials used in the semiconductor process can include semiconductors, metals, or insulators. The in situ monitoring includes mid-process characterization of the thin film, where substrate can be transferred from any chamber to the monitoring system during processing for cycle-by-cycle in situ imaging such as local density-of-states (LDOS) of features on a sample. The mid-process characterization includes determination of features in the thin film, where the features can include trench depth, material composition, capacitance measurements, feature height, feature spacing or size uniformity, elastic modulus, and further can include characterization of micro-electromechanical systems (MEMS) to determine dimensions.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. A method of in situ monitoring of semiconductor processes, comprising:
a. monitoring said semiconductor processes in situ using a scanning probe microscope (SPM), wherein a second partition is located above said first partition, wherein said second partition is hermetically isolated from said first partition, wherein a SPM probe tip of said SPM is disposed in said first partition, wherein a remaining portion of said SPM is disposed in said second partition that is hermetically isolated from said first partition.

2. The method according to claim 1, wherein said semiconductor process comprises an atomic layer deposition (ALD) process in said first partition, wherein said ALD process comprises a viscous-flow process utilizing sequential flow and purging of precursor and oxidant species to deposit a thin film.

3. The method according to claim 1, wherein said semiconductor process is selected from the group consisting of deposition, etching, polishing, thermal, annealing, cleaning, liftoff, lithography, and implantation.

4. The method according to claim 3, wherein materials used in said semiconductor process are selected from the group consisting of semiconductors, metals, and insulators.

5. The method according to claim 1, wherein said in situ monitoring comprises mid-process characterization of said thin film, wherein said mid-process characterization enables early detection of errors in processing, wherein defective wafers are recycled or reprocessed.

6. The method according to claim 1, wherein said in situ monitoring comprises mid-process characterization of said thin film, wherein said mid-process characterization comprises determination of features in said thin film, wherein said features are selected from the group consisting of trench depth, material composition, feature height, feature spacing, size uniformity, capacitance, and elastic modulus.

7. The method according to claim 1, wherein said in situ monitoring comprises mid-process characterization of said thin film, wherein said mid-process characterization comprises characterization of micro-electromechanical systems (MEMS) to determine dimensions.

8. The method according to claim 1, wherein said in situ monitoring comprises cycle-by-cycle in situ imaging.

9. The method according to claim 1, wherein a pressure differential between said first partition and said second partition is up to 10 torr.

10. The method according to claim 1, wherein a pressure ratio exists between said first partition and said second partition, wherein said pressure ratio comprises a pressure less than 10⁻⁶ Torr in said first partition and a pressure in said second partition that is less than 10 Torr.

11. The method according to claim 1, wherein in situ monitoring comprises measuring a local density-of-states (LDOS) of features on a sample.

12. The method according to claim 1, wherein said semiconductor processes occurs in said first partition.

13. The method according to claim 1, wherein said semiconductor process occurs in a third partition, wherein said third partition is mechanically connected to said first partition and said second partition.

14. The method according to claim 13, wherein said first partition and said third partition comprises a cluster tool, wherein substrates are passed between said cluster tool by robotic transfer arms while remaining isolated from an ambient environment, wherein said substrate remains in a vacuum environment during said processing.
